(19) United States
(12) Patent Application Publication
(10) Pub. No.: US 2024/0249266 A1
(43) Pub. Date: Jul. 25, 2024

(54) INTEGRATION OF VISUAL ANALYTICS AND AUTOMATIC ITEM RECOGNITION AT ASSISTED CHECKOUT

(71) Applicant: RadiusAI, Inc., Tempe, AZ (US)

(72) Inventors: Abhinav Yarlagadda, Woodinville, WA (US); Enis Dengi, Tempe, AZ (US); Sai Krishna Bashetty, Bellevue, WA (US); Rahul Santhosh Kumar Varma, Tempe, AZ (US); Daniel King, Seattle, MA (US); Kamalesh Kalirathinam, Tempe, AZ (US); Nathan Kelly, Phoenix, AZ (US); Sri Priyanka Madduluri, Arlington, VA (US); Thomas Strich, Tempe, AZ (US)

(21) Appl. No.: 18/414,298

(22) Filed: Jan. 16, 2024

Related U.S. Application Data
(60) Provisional application No. 63/439,113, filed on Jan. 14, 2023.
(60) Provisional application No. 63/439,149, filed on Jan. 15, 2023.
(60) Provisional application No. 63/587,874, filed on Oct. 4, 2023.

(51) Int. Cl. G06Q 20/20; G06V 10/40; G06V 10/82

(52) U.S. Cl. CPC G06Q 20/208; G06V 10/40; G06V 10/82

(57) ABSTRACT

Systems and methods include extracting item parameters from images of items positioned at a POS system. The item parameters associated with each item are indicative as to an identification of each item thereby enabling the identification of each item based on the item parameters. The item parameters are analyzed to determine whether the item parameters match item parameters stored in a database. The database stores different combinations of item parameters to thereby identify each item based on each different combination of item parameters associated with each item. Each item positioned at the POS system is identified when the item parameters for each item match item parameters as stored in the database and fail to identify each item when the item parameters fail to match item parameters. The item parameters associated with the items that fail to match are streamed to the database thereby enabling the identification of each failed item.

### CROSS-REFERENCE TO RELATED APPLICATIONS

The present application is a PCT patent application which claims the benefit of U.S. Provisional Application No. 63/439,149 filed Jan. 15, 2023, and also claims the benefit of U.S. Provisional Application No. 63/439,113, filed Jan. 14, 2023, and also claims the benefit of U.S. Provisional Application No. 63/587,874, filed on Oct. 4, 2023 both of which are incorporated herein by reference in their entirety. This application also incorporates U.S. Nonprovisional Application No. herein by reference in its entirety.

### BACKGROUND

Retailers often incorporate self-checkout systems at the Point of Sale (POS) in order to decrease the wait time of customers to have their selected items scanned and purchased at the POS. Self-checkout systems also reduce the footprint required for the checkout systems as assisted checkout systems require less footprint than traditional checkout systems that are staffed with a cashier. Self-checkout systems also reduce the quantity of cashiers required to staff the self-checkout systems as one or two cashiers may be able to manage several self-checkout systems rather than having a cashier positioned at every checkout system.

Self-checkout systems require the customer to scan one selected item for purchase at a time once positioned at the POS for items which have a Universal Product Code (UPC) which is scanned by the customer at the POS thereby identifying the item based on the scanned UPC. Selected items for purchase that do not have a UPC require the customer to then navigate through the self-checkout system to type in the name of the item without a UPC and then select the item in that manner. Errors often happen in which an item was not properly scanned and/or properly identified causing the self-checkout system to pause and require intervention by the cashier. Conventionally, self-checkout systems require intense interaction by the customer to essentially execute the checkout of the items by themselves. Self-checkout systems also increase the wait time for customers to checkout due to the pausing of the self-checkout systems and requiring the intervention of the cashier before continuing with the checkout process.

### BRIEF SUMMARY

Embodiments of the present disclosure relate to providing a point of sale (POS) system that automatically identifies items positioned at the POS for purchase based on images captured of the items by cameras positioned at the POS as well as cameras positioned throughout the retail location. A system may be implemented to automatically identify a plurality of items positioned at a POS system based on a plurality of item parameters associated with each item as provided by a plurality of images captured by a plurality of cameras positioned at the POS system. The system includes at least one processor and a memory coupled with the at least one processor. The memory includes instructions that when executed by the at least one processor cause the processor extract the plurality of item parameters associated with each item positioned at the POS system from the plurality of images captured of each item by the plurality of cameras positioned at the POS system. The item parameters associated with each item when combined are indicative as to an identification of each corresponding item thereby enabling the identification of each corresponding item. The processor is configured to analyze the item parameters associated with each item positioned at the POS system to determine whether the item parameters associated with each item when combined matches a corresponding combination of the item parameters stored in an item parameter identification database. The item parameter identification database stores different combinations of item parameters with each different combination of item parameters associated with a corresponding item thereby identifying each corresponding item based on each different combination of item parameters associated with each corresponding item. The processor is configured to identify each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters. The processor is configured to stream the item parameters with each item positioned at the POS system that fail to match to the item parameter identification database thereby enabling the identification of each failed item when the combination of item parameters of each failed item are subsequently identified when subsequently positioned at the POS system after the failed match.

In an embodiment, a method automatically identifies a plurality of items at a Point of Sale (POS) system based on a plurality of item parameters associated with each item as provided by a plurality of images captured by a plurality of cameras positioned at the POS system. The plurality of item parameters associated with each item positioned at the POS system may be extracted from the plurality of images captured of each item by the plurality of cameras positioned at the POS system. The item parameters associated with each item when combined are indicative as to an identification of each corresponding item thereby enabling the identification of each corresponding item. The item parameters associated with each item positioned at the POS system may be analyzed to determine whether the item parameters associated with each item when combined matches a corresponding combination of the item parameters stored in an item parameter identification database. The item parameter identification database stores different combinations of item parameters with each different combination of item parameters associated with a corresponding item thereby identifying each corresponding item based on each different combination of item parameters associated with each corresponding item. Each corresponding item positioned at the POS system may be identified when the item parameters associated with each item when combined match a corresponding combination of item parameters as stored in the item parameter identification database and fail to identify each corresponding item when the item parameters associated with each item when combined fail to match a corresponding combination of item parameters. The item parameters associated with each item positioned at the POS system that fail to match to the item parameter identification database may be streamed thereby enabling the identification of each failed item when the combination of item parameters of each failed item are subsequently identified when subsequently positioned at the POS system after the failed match.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 depicts an illustration of an item identification configuration; and

FIG. 2 depicts a video analytic item identification configuration in which video analytic item identification system integrates item identification configuration with a video analytics system in order to assist item identification computing device in identifying items based on customer journey data captured by the video analytics system as the customer maneuvers throughout the retail location.

### DETAILED DESCRIPTION

Embodiments of the disclosure generally relate to providing a system for assisted checkout in which items positioned at the Point of Sale (POS) system are automatically identified thereby eliminating the need for the customer and/or cashier to scan and/or identify items that cannot be scanned manually. In an example embodiment, the customer approaches the POS system and positions the items which the customer requests to purchase at the POS system. Cameras positioned at the POS system capture images of each item and then an item identification computing device may then extract item parameters associated with each item from the images captured of each item by the cameras. The item parameters associated with each item are specific to each item and when combined may identify the item thereby enabling identification of each corresponding item. Item identification computing device may then automatically identify each item positioned at the POS system based on the item parameters associated with each item as extracted from the images captured of each item. In doing so, the customer simply has to position the items at the POS system and is not required to scan and/or identify items that cannot be scanned. The cashier simply needs to intervene when there is an issue when an item is not identified by item computing device.

However, in an embodiment, item identification computing device may continuously learn via a neural network in identifying each of the numerous items that may be positioned at the POS system for purchase by the customer. Each time that an item that is positioned at the POS system for purchase that item identification computing device does not identify, such item parameters associated with the unknown item may be automatically extracted from the images captured of the unknown by item identification computing device and provided to a neural network. The neural network may then continuously learn based on the item parameters of the unknown item thereby enabling item identification computing device to correctly identify the previous unknown item in subsequent transactions. The unknown item may be presented at numerous different locations in which item identification computing device automatically extracts the item parameters of the unknown item as presented at numerous different locations and provided to the neural network such that the neural network may continuously learn when the unknown item is presented at any retail location thereby significantly decreasing the duration of time required for item identification computing device to correctly identify the previously unknown item.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

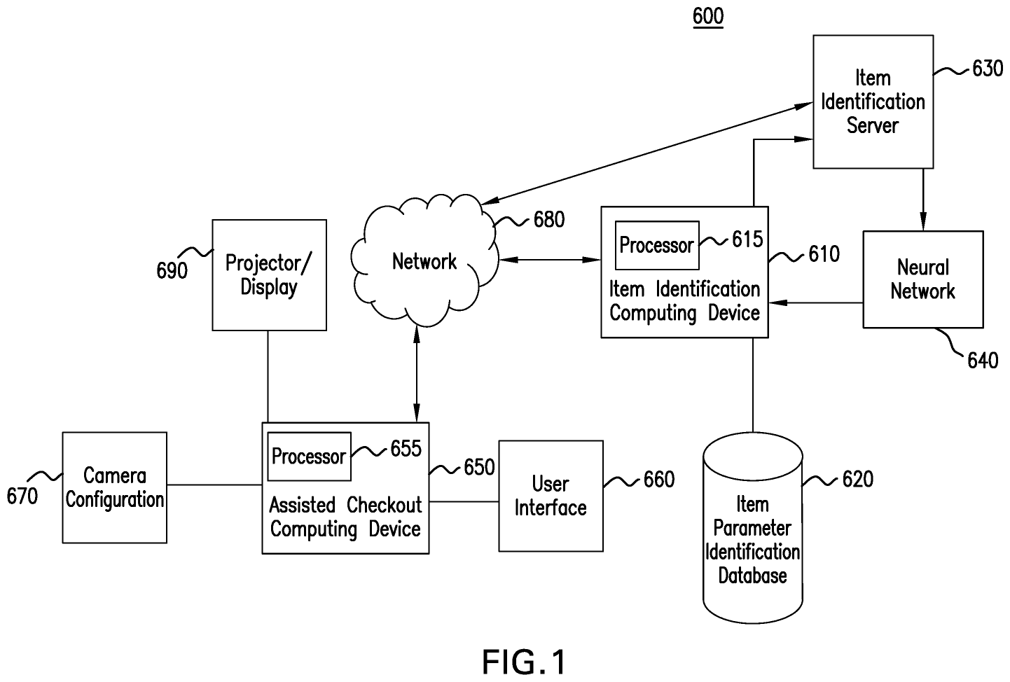

As shown in FIG. 1, an item identification configuration 600 includes an item identification computing device 610, an assisted checkout computing device 650, a camera configuration 670, a user interface 660, a projector/display 690, an item identification server 630, a neural network 640, an item parameter identification database 620, and a network 680. Image identification computing device 610 includes a processor 615. Assisted checkout computing device 650 includes a processor 655.

The checkout process, during which items intended to be purchased by a customer are identified, and prices tallied, by an assigned cashier. The term Point of Sale (POS) is the area within a retail location at which the checkout process occurs. Conventionally, the checkout process presents the greatest temporal and spatial bottleneck to profitable retail activity. Customers spend time spent waiting for checkout to commence in a checkout line staffed by a cashier where the cashier executes the checkout process and/or in a line waiting to engage a self-checkout station and completing checkout where the cashier scans the items individually and/or the customer scans the items individually in a self-checkout station.

As a result, the checkout process reduces the turnover of customers completing customer journeys within the retail location in which the customer journey of the customer is initiated when the customer arrives at the retail location and continues as the customer proceeds through the retail location, and concludes when the customer leaves the retail location. The reduction in turnover in the customers completing customer journeys results in a reduction of sales by the retailer as customers are simply proceeding through the retail location less and thereby reducing the opportunity for the customers to purchase items. The conventional checkout process also impedes the flow of customer traffic within the retail location and also serves as a point of customer dissatisfaction in the shopping experience, as well as posing a draining and repetitive task for cashiers. Customers also appreciate and expect human interaction during checkout, and conventional self-checkout systems are themselves a point of aggravation in the customer experience.

Item identification configuration 600 may provide a defined checkout plane upon which items are placed at the POS system for recognition by item identification computing device 610. Assisted checkout computing device 650 may then automatically list items presented at the POS system for purchase by their customer and tally the prices of the items automatically identified by item identification computing device 610. In doing so, the human labor associated with scanning the items one-by-one and/or identifying the items one-by-one may be significantly reduced for the cashiers as well as the customers. Item identification configuration 600 may implement artificial intelligence to recognize the items placed on the checkout plane at the POS system at once, even when such items may be bunched together to occlude views of portions of some of the items, and of continually improving the recognition accuracy of item identification computing device 610 through machine learning.

A customer may enter a retail location of a retailer and browse the retail location for items in which the customer requests to purchase from the retailer. The retailer may be an entity that is selling items and/or services for purchase. The retail location may be a brick and mortar location and/or an on-site location that the customer may physically enter and/or exit the retail location when completing the customer journey of the customer in order to purchase the items and/or services located at the retail location. As noted above, the retail location also includes a POS system in which the customer may engage to ultimately purchase the items and/or services from the retail location. The customer may then approach the POS system to purchase the items in which the customer requests to purchase.

In doing so, the customer may present the items at the POS system in which the POS system includes a camera configuration 670. Camera configuration 670 may include a plurality of cameras positioned in proximity of the checkout plane such that each camera included in camera configuration 670 may capture different perspectives of the items positioned in the checkout plane by the customer. For example, the checkout plane may be a square shape and camera configuration 670 may then include four cameras in which each camera is positioned in one of the corresponding corners of the square-shaped checkout plane. In doing so, each of the four cameras may capture a different perspective of the square-shaped checkout plane thereby also capturing a different perspective of the items positioned on the checkout plane for purchase by the customer. In another example, camera configuration 670 may include an additional camera positioned above the checkout plane and/or an additional camera positioned below the checkout plane. Camera configuration 670 may include any quantity of cameras positioned in any type of configuration to capture different perspectives of the items positioned in the checkout plane for purchase that will be apparent to those skilled in the relevant art(s) without departing from the spirit and scope of the invention.

The POS system may also include assisted checkout computing device 650. Assisted checkout computing device 650 may be the computing device positioned at the POS system that enables the customer and/or cashier to engage the POS system. Assisted checkout computing device 650 may include user interface 660 such that user interface displays each of the items automatically identified as positioned at the POS system for purchase as well as the price of each automatically identified item as well as the total cost of the automatically identified item. Assisted checkout computing device 650 may also display via user interface any items that were not automatically identified and enable the cashier and/or customer to scan the unidentified item. Assisted checkout computing device 650 may be positioned at the corresponding POS system at the retail location.

One or more assisted checkout computing devices 650 may engage item identification computing device 610 as discussed in detail below in order to interface with of each of the customers and/or cashiers in real-time via user interface 660 with regard to their request for purchase of the item. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be a device that is identifying items provided to assisted checkout computing device 650 for purchase based on images captured by camera configuration 670. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be positioned at the retail location, may be positioned at each POS system, may be integrated with each assisted checkout computing device 650 at each POS system, may be positioned remote from the retail location and/or assisted checkout computing device 650 and/or any other combination and/or configuration to automatically identify each item positioned at the POS system and then the identification displayed by assisted checkout computing device 650 that will be apparent to those skilled in the relevant art(s) without departing from the spirit and scope of the invention.

Rather than have a cashier then proceed with scanning the items in which the customer requests to purchase and/or have the customer scan such items as positioned at the POS system, item identification computing device 610 may automatically identify the items in which the customer requests to purchase based on the images captured of the items by camera configuration 670. Assisted checkout computing device 650 may then automatically display the items in which the customer requests to purchase via user interface 660 based on the automatic identification of the items by item identification computing device 610. The customer may then verify that the displayed items are indeed the items that the customer requests to purchase and proceed with the purchase without intervention from the cashier.

As a result, the retailer may request that numerous items in which the retailer has for purchase in the numerous retail locations of the retailer be automatically identified by item identification computing device 610 as the customer presents any of the numerous items at the POS system to purchase. The retailer may have numerous items that differ significantly based on different item parameters. Each item includes a plurality of item parameters that when combined are indicative as to an identification of each corresponding item thereby enabling identification of each item by item identification computing device 610 based on the item parameters of each corresponding item. The item parameters associated with each item may be specific to the corresponding item in which each time the item is positioned at the POS system, the images captured of the corresponding item by camera configuration 670 depict similar item parameters thereby enabling item identification computing device 650 to identify the item each time the item is positioned at the POS system. The item parameters associated with each item may also be repetitive in which substantially similar items may continue to have the same item parameters such that the item parameters provide insight to item identification computing device 610 as to the item that has been selected for purchase by the customer. In doing so, the item parameters may be repetitively incorporated into substantially similar items such that the item parameters may continuously be associated with the substantially similar items thereby enabling the item to be identified based on the item parameters of the substantially similar items.

For example, a twelve ounce can of Coke includes item parameters specific to the twelve ounce can of Coke such as the shape of the twelve ounce can of Coke, the size of the twelve ounce can of Coke, the lettering on the twelve ounce can of Coke, the color of the twelve ounce can of Coke and so on. Such item parameters are specific to the twelve ounce can of Coke and differentiate the twelve ounce can of Coke from other twelve ounce cans of soda pop thereby enabling item identification computing device 610 to automatically identify the twelve ounce can of Coke based on such item parameters specific to the twelve ounce can of Coke. Additionally, each twelve once can of Coke as canned by Coca-Cola and distributed to the retail locations include substantially similar and/or the same item parameters as every other twelve ounce can of Coke canned by Coca-Cola and then distributed to the retail locations. In doing so, each time a twelve ounce can of Coke is positioned at any POS system at any retail location, item identification computing device 610 may automatically identify the twelve ounce can of Coke based on the repetitive item parameters specific to every twelve ounce can of Coke.

Item parameters may include but not limited to such as brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention.

In doing so, each item in which the retailer requests to be automatically identified by and displayed by assisted checkout computing device 610 may be presented to item identification computing device 610 such that item identification computing device 610 may be trained to identify each item in offline training. The training of item identification computing device 610 in offline training occurs when the item is provided to item identification computing device 610 for training offline from when the item is presented to assisted checkout computing device 650 such that offline training occurs independent from actual purchase of the item as presented to assisted checkout computing device 650. Each item may be presented to item identification computing device 610 such that item identification computing device 610 may scan each item to incorporate the item parameters of each item as well as associate the item parameters with a UPC and/or SKU associated with the item. Item identification computing device 610 may then associate the item parameters of the item to the UPC and/or SKU of the item and store such item parameters that are specific to the item and correlate to the UPC and/or SKU of the item in the item parameter identification database 620. For purpose of simplicity, UPC may be used throughout the remaining specification but such reference may include but is not limited to UPCs, IANs, EANs, SKUs, and/or any other scan related identification protocol that will be apparent from those skilled in the relevant art(s) without departing from the spirit and scope of the present disclosure.

Each iteration that the item is scanned by item identification computing device 610, such item parameters of the item of each scan may further be stored in item parameter identification database 620. The item parameters captured for each iteration of scanning the item may then be provided to item identification server 630 and incorporated into neural network 640 such that neural network 640 may continue to learn as to the item parameters associated with the item for each iteration thereby increasing the accuracy of item identification computing device 610 correctly identifying the item. In doing so, assisted checkout computing device 650 also increases the accuracy in displaying to the customer via user interface 660 the correct identification of the item in which the customer presents to the POS system to request to purchase thereby streamlining the purchase process for the customer and the retailer.

However, such training of item identification computing device 610 occurs in offline training in which the retailer presents a list of the items that the retailer requests to be automatically identified in which the list includes the item and corresponding UPC. Each item on the list is then provided to item identification computing device 610 and each item is continuously scanned by identification computing device 610 in order for a sufficient quantity of iterations to be achieved until item identification computing device 610 may accurately identify the item. Such offline iterations is time consuming and costly as assisted checkout computing device 650 may fail in accurately displaying the identification of the item to the customer via user interface 660 in which the customer requests to purchase until item identification computing device 610 has obtained the sufficient of quantity of iterations to correctly identify the item via neural network 640.

Further, the retailer may continuously be adding new items to the numerous retail locations of the retailer in which such new items are available to purchase by the customer. Item identification computing device 610 may have not had the opportunity to be trained on the continuously added new items in offline training. Often times, the retailer has numerous retail locations and the retailer may not have control over their own supply chain. In doing so, the retailer may not know when items will be arriving each of the numerous retail locations as well as when the items will be ultimately purchased and discontinued at each of the numerous retail locations. As a result, item identification computing device 610 may not have the opportunity to execute offline learning of such numerous items at each of the numerous retail locations. In doing so, the new items may be continuously presented for purchase to assisted checkout computing device 650 but assisted checkout computing device 650 may fail to correctly display identification of the item to the customer via user interface 660 due to item identification computing device 610 not having the opportunity to receive the quantity of iterations in offline training to identify the new items.

However, each time that the customer presents an item to assisted checkout computing device 650 in which item identification computing device 610 may not have had sufficient iterations to train in offline manner to identify the item may actually be an iteration opportunity for item identification computing device 610 to train in identifying the item in online training. Item identification computing device 610 may train in identifying the item in online training when the customer presents the item to assisted checkout computing device 650 for purchase such that camera configuration 670 captures images of the item parameters associated with the item thereby enabling item identification computing device 610 to capture an iteration of training at the POS system of the item rather than doing so offline.

The retailer may experience numerous transactions in which the customer requests to purchase the item in which item identification computing device 610 has not had the opportunity to sufficiently train in offline training. Such numerous transactions provide the opportunity for item identification computing device 610 to train in online training to further streamline the training process in identifying the items. Further, the training of item identification computing device 610 with iterations provided by the customer requesting to purchase the item at the POS system further bolsters the accuracy in the identification of the item by item identification computing device 610 even after item identification computing device has been sufficiently trained with iterations in offline training. Thus, the time in which to train item identification computing device 610 to accurately identify the item is decreased as well as the overhead to do so by adding the online training to supplement the offline training of item identification computing device 610.

As a result, the automatic identification of the items positioned at assisted checkout computing device 650 at the POS by item identification computing device 610 may enable the retailer to have the staff working at each retail location to execute tasks that have more value than simply scanning items. For example, the staff working at each retail location may then greet customers, stock shelves, perform office administration, and/or any other task that provides more value to the retailer as compared to simply scanning items. In doing so, the retailer may reduce the quantity of staff working at each retail location during each shift while also gaining move value from such staff working at each retail location during each shift due to the increase in value of the tasks that each staff member may now execute without having to scan items and/or manage a conventional self-checkout system that fails to automatically identify the items positioned at such conventional POS systems. The automatic identification of the items positioned at assisted checkout computing device 650 at the POS may also enable the retailer to execute a fully autonomous self-checkout system in addition to also reducing staff. Regardless, the automatic identification of the items positioned at assisted checkout computing device 650 at the POS provides the retailer with increased flexibility in staffing each retail location during each shift.

Item identification computing device 610 may be a device that is identifying items provided to assisted checkout computing device 650 for purchase based on images captured by camera configuration 670. One or more assisted checkout computing devices 650 may engage item identification computing device 610 in order to interface with of each of the customers and/or cashiers in real-time via user interface 660 with regard to their request for purchase of the item. User interface 660 may include any type of display device including but not limited to a touch screen display, a liquid crystal display (LCD) screen, a light emitting diode (LED) display and/or any other type of display device that includes a display that will be apparent from those skilled in the relevant art(s) without departing from the spirit and scope of the present disclosure.

Communication between assisted checkout computing device 650, item identification computing device 610, and/or item identification server 630 may occur via wireless and/or wired connection communication. Wireless communication may occur via one or more networks 680 such as the internet or Wi-Fi wireless access points (WAP). In some embodiments, network 680 may include one or more wide area networks (WAN) or local area networks (LAN). The network may utilize one or more network technologies such as Ethernet, Fast Ethernet, Gigabit Ethernet, virtual private network (VPN), remote VPN access, a variant of IEEE 802.11 standard such as Wi-Fi, and the like. Communication over network 680 takes place using one or more network communication protocols including reliable streaming protocols such as transmission control protocol (TCP), Ethernet, Modbus, CanBus, EtherCAT, ProfiNET, and/or any other type of network communication protocol that will be apparent from those skilled in the relevant art(s) without departing from the spirit and scope of the present disclosure. Wired connection communication may occur but is not limited to a fiber optic connection, a coaxial cable connection, a copper cable connection, and/or any other type of direct wired connection that will be apparent from those skilled in the relevant art(s) without departing from the spirit and scope of the present disclosure. These examples are illustrative and not intended to limit the present disclosure.

### Integration of Visual Analytics and Automatic Item Recognition at Assisted Checkout

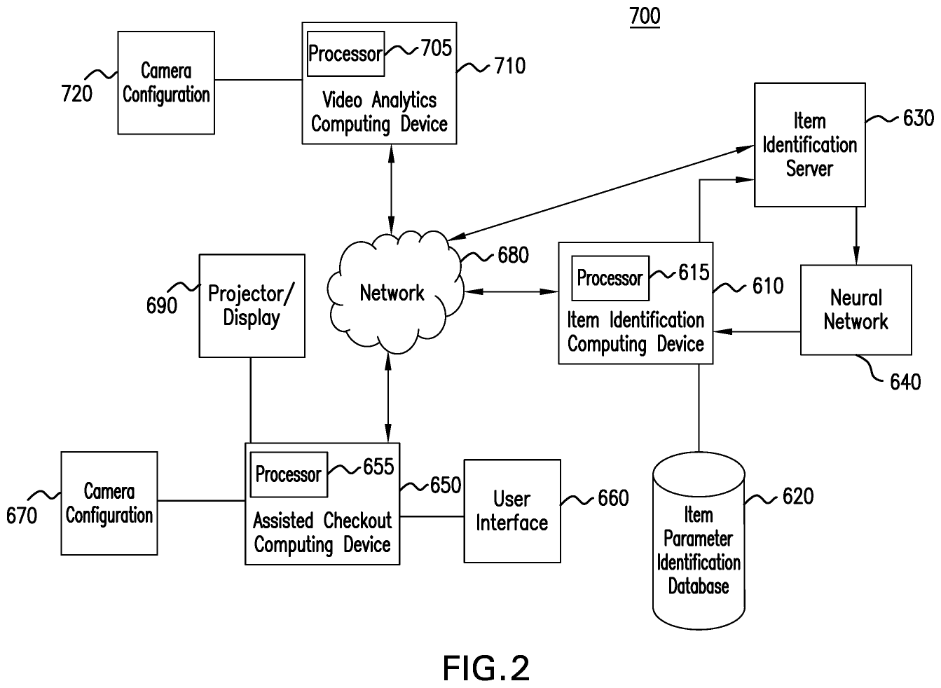

FIG. 2 depicts a video analytic item identification configuration 700 in which video analytic item identification system 700 integrates item identification configuration 600 with a video analytics system in order to assist item identification computing device 610 in identifying items based on customer journey data captured by the video analytics system as the customer maneuvers throughout the retail location. Video analytic item identification system 700 includes vide analytics computing device 710 and camera configuration 720. Video analytics computing device 710 includes processor 705.

Video analytic item identification configuration 700 may be integrated with camera configuration 720 and with item identification system 600 and camera configuration 720. Camera configuration 720 may include a plurality of cameras positioned throughout the retail location that capture customers completing customer journeys within the retail location in which the customer journey of the customer is initiated when the customer arrives at the retail location and continues as the customer proceeds through the retail location, and concludes when the customer leaves the retail location. Camera configuration 720 may capture the customer journey as the customer arrives at the parking lot of the retail location as well as the customer journey of the customer when the customer is within the retail location and then when the customer departs the parking lot of the retail location.

Item identification computing device 610 may then based on the images captured of camera configuration 720 of the customer journey of the customer throughout the retail location may identify the items in which the customer engages during the customer journey and ultimately provides to the POS system for purchase before the customer reaches the POS system. Item identification computing device 610 may then confirm the identification of items as identified from video analytics computing device 710 based on the item identification executed by item identification computing device 610 at the POS system from the images captured by camera configuration 670 of the item at the POS system. In doing so, the capturing of the customer journey of the customer throughout the retail location to identify the items engaged by the customer may be combined with the item identification of the items positioned at the POS system by the customer to determine the items that the customer ultimately requests to purchase as well as any items that the customer may remove from the retail location without the proper purchase. As a result, an increased checkout experience may be provided to the customer as well as increasing loss prevention for the retailer without providing significant costs and changes to the infrastructure of the retail location to do so.

Conventional retail tracking systems require that numerous cameras be methodically positioned throughout the retail location. Such numerous cameras are required in addition to the already existing cameras positioned at the retail location such that the conventional retail tracking systems may adequately identify any item that is selected by the customer. Conventional retail tracking systems fail to simply implement the existing cameras positioned at the retail location as such conventional retail tracking systems do not have the learning capabilities to adequately identify the items in which the customer engages based on learning on item parameters associated with past items that have been engaged by past customers executing past customer journeys. As a result, conventional retail tracking systems fail to continue to identify an item engaged by the customer by simply handing off the tracking of the engaged item to each of the already existing cameras at the retail location. Rather, conventional retail tracking systems require such numerous cameras to be installed at the retail location to ensure that the identification of the item is not lost when moved from the field of view of each camera.

Further, conventional retail tracking systems require that the retail location revamp the layout of the retail location to fit a pre-emptive layout of the retail location to be customized to the conventional retail tracking systems. As discussed above, conventional retail tracking systems lack the learning capabilities to adequately identify the items in which the customer engages based on learning on item parameters associated with past items that have been engaged by past customers executing past customer journeys. As a result, conventional retail tracking systems require to pre-emptively know where each item is positioned in the retail location such that the numerous cameras also positioned in the retail location may then identify the item engaged by the customer based on pre-emptively knowing exactly where the item is initially positioned for sale at the retail location.

Further, conventional retail tracking systems require that specific items not be positioned in close proximity to other specified items. Conventional retail tracking systems struggle to adequately identify different items that may have similar item parameters. Different items that have similar item parameters that positioned in close proximity to each other may appear to be the same item to the conventional retail tracking systems resulting in the conventional retail tracking systems to mistakenly identify the different items with similar item parameters when initially positioned in close proximity to each other at the outset of being engaged by the customer. As a result, conventional retail tracking systems require that different items with similar item parameters be positioned sufficiently apart from each other at the retail location to differentiate between the different items with similar item parameters avoid the conventional retail tracking systems from mistakenly identifying the different items with similar item parameters.

Thus, conventional retail tracking systems require retailers to add numerous cameras to the retail location in addition to the existing cameras already positioned at the retail location which is a significant increase in cost. Conventional retail tracking systems also require that the retailers essentially rip up the existing layout of the retail location to satisfy the pre-emptive layout required for the conventional retail tracking systems to identify the items. Such a revamp of the existing layout of the retail location significantly impacts the ability of the retailer to sell and market the items as the retailer understands the optimum positioning of items for selling and marketing the items. A revamp of the existing layout of the retail location to satisfy the pre-emptive layout required for the conventional retail tracking systems to identify the items not only is an significant increase in cost but also significantly impacts the sale and marketing of the items by the retailer in the retail location.

Rather than require the retailer to add numerous cameras to the retail location as well as revamp the existing layout of the retail location to satisfy the pre-emptive layout required for the conventional retail tracking systems to identify the items, video analytic item identification configuration 700 may implement the existing cameras already positioned at the retail location by the retailer as well as adapt to the existing layout and/or any future layout of the retail location based on the objectives of the retailer. The automatic identification of items throughout the customer journey of the customer as well as the automatic identification of items positioned at the POS system for purchase by the customer enables video analytic item identification configuration 700 to adequately identify items throughout the customer journey as well as verification at the POS system without having to change the existing camera configuration and/or layout of the retail location. As a result, video analytic item identification configuration 700 may increase the customer experience throughout the checkout process as well as increasing loss prevention for the retailer without providing significant costs, changes to the infrastructure of the retail location as well as preventing disruption to the retailer and/or retail location.

As discussed above, item identification computing device 610 may identify items presented by the customer to assisted checkout computing device 650 for purchase. However, as discussed above, each of the items presented by the customer to assisted checkout computing device 650 for purchase include items that have a UPC associated with each of the items. Granted, such UPC may be unknown to item identification computing device 610 in which the unknown item has yet to be included in the master list of item parameter identification database 620 in which the UPC of the unknown item is unknown. The UPC of the unknown item may be partially blocked such that camera configuration 670 may only capture a portion of the UPC. The UPC of the unknown item may not be captured at all by camera configuration 670 thereby triggering item identification computing device 610 to identify the unknown item based on the item parameters associated with the item. Regardless, each of the instances discussed above are associated with items that have UPCs associated with the items.

However, the retailer may offer for purchase numerous items in which such items do not have a UPC associated with the items. Such items may include items in which such items may not be feasibly associated with a UPC. Such items may be items that the retailer associates a price to the item at the POS when the customer presents the item to assisted checkout computing device 650 for purchase. In doing, such items that are not priced in a pre-meditative manner in which a UPC is easily associated with the item such that the price of the item follows the item throughout the customer journey throughout the retail location. Rather, such items are carried throughout the customer journey of the customer throughout the retail location in which the price of such item is associated with the item at the POS as presented to assisted checkout computing device 650 for purchase by the customer. At any moment during the customer journey of the customer throughout the retail location, such items many not be scanned by an employee of the retail location to provide more information to the customer as provided by the scanning of the UPC of the item due to the item simply not having a UPC associated with the item due to lack of feasibility. Such information would have to be presented to the customer via signage positioned by the items at the retail location and/or ultimately priced at the POS when the customer provides the item to assisted checkout computing device 650.

For example, such items are items that are not produced and/or packaged by the manufacturer in which such items are sealed and associated with a UPC on the packaging of such items. As a result, such items are not items in which each similar item manufactured by the manufacturer are packaged with similar item parameters which may easily identify the similar items in addition to have a UPC provided on the packaging of the items. In another example, such items may also be items in which tagging such items with a UPC by the retailer is also not feasible, such as tagging produce with UPCs in which tagging the produce with UPCs does not harm the quality of the produce.

Rather, such items may be items offered for purchase at the retail location in which each item although of a similar class may have item parameters that differentiate for each item of similar class and/or have item parameters that distinctly identify the item. For example, the retailer may offer for purchase at the different retail locations hot food, such as a chicken/cheese/beef burrito, in which each of the burritos offered for purchase at the retail location are packaged in aluminum foil which is simply generic aluminum foil without and any labelling to identify what is in the aluminum foil. In such an example, the chicken burrito for purchase may differ in cost to purchase from the cheese burrito and the beef burrito. Further, even if the cost to purchase each of the chicken burrito, the cheese burrito, and the beef burrito are the same, the packaging of each burrito in generic aluminum foil is difficult to differentiate which burrito is being purchased for purchase tracking purposes by the retailer. In doing so, each of the different burritos offered for purchase by the retailer at the retail location may also be wrapped in simply generic aluminum foil and may also have similar item parameters of metrology to the burritos wrapped in generic aluminum foil. Thus, differentiating the different burritos wrapped in generic aluminum foil at the POS system of when presented to assisted checkout computing device 650 for purchase by the customer may be difficult based on the similar size, shape, and so on of the burritos. As a result, such items do not have a UPC associated with the items.

Such items may be items offered for purchase at the retail location in which several items may be incorporated into an assembled item for purchase by the customer while at the retail location. For example, the retailer may offer for purchase hot dogs in which the customer may add different toppings and/or condiments when assembling the final hot dog that the customer requests to purchase and are then packaged in an aluminum foil and/or a generic container without any labeling to identify not only what is in the generic packaging in the hot dog but also what toppings and condiments were added to the hot dog. In such an example, hot dogs that are assembled by the customer with toppings and condiments and wrapped in generic packaging may be difficult to identify not only the hot dog but also the toppings and condiments that the retailer may also charge for purchase at the POS when presented to assisted checkout computing device 650 for purchase by the customer. As a result, such items do not have a UPC associated with the items.

From a product perspective, video analytic item identification configuration 700 may support assembled and non-packaged products offered for sale in retail stores by the retailer. Fresh food and drinks typically fall under this category where video analytic item identification configuration 700 may need to identify the combination of items that went into the order. For example, hot dogs in which video analytics identification configuration 700 may need to identify the combination of items that went into the order. In such an example, hot dogs may be assembled by the customer where the customer adds different condiments to the top of the hot dog. In another example, different flavors of items may be wrapped in a plain package such as a chicken/cheese/beef burrito, in which all of such items are wrapped in an aluminum foil. Such an integration may possibly aid in loss prevention use cases.

Thus, integrating video analytics computing device 710 and camera configuration 720 with item identification computing device 610, assisted checkout computing device 650, and camera configuration 1970 may incorporate customer journey item parameters associated with the items which are not associated with a UPC to the item parameters associated with such items that are already analyzed by item identification computing device 610 as discussed above. Customer journey item parameters are parameters associated with the item that the customer requests to purchase that are generated from the customer journey of the customer in the retail location in which the customer executed in engaging the item that is not associated with a UPC. Such customer journey item parameters complement the item parameters of the item but provide more insight as to identifying the item without a UPC when such item parameters of the item fail to explicitly identify the item.

The customer journey item parameters may be parameters that are generated by video analytics computing device 710 in which video analytics computing device 710 analyzes the images captured by camera configuration 720 of the customer journey in the retail location to provide insight as to the items in which the customer requests to purchase. Camera configuration 720 may be cameras positioned throughout the retail location that track the customer journey of the customer throughout the retail location from when the customer enters the retail location to when the customer departs the retail location and thereby captures all of the images of the actions of the customer as well as the retail location itself as the customer executes the customer journey throughout the retail location. As discussed above, camera configuration 720 may include already existing cameras positioned at the retail location by the retailer and do not require additional cameras to be installed at the retail location. Video analytics computing device 710 may then analyze the images captured by camera configuration 720 to generate customer journey item parameters that provide an insight as to what the customer did and the corresponding portions of the retail location that may provide additional indication to identifying the items that the customer requests to purchase.

Item identification computing device 610 may recognize the items that the customer engages during the customer journey of the customer throughout the retail location based on multi-camera tracking in which camera configuration 720 may capture images of the customer as the customer maneuvers through the retail location as well as the items that the customer engages. Item identification computing device 610 may then incorporate the customer journey item parameters generated by video analytics computing device 710 from the analysis of the images of the customer journey as captured by camera configuration 720. Item identification computing device 610 may then already recognize the items that the customer positons at the POS system for purchase before the customer positions the items at the POS system for purchase based on the customer journey item parameters for each item as generated by video analytics computing device 710. Item identification computing device 610 may then confirm the identification of the items positioned at the POS system based on the item parameters extracted from the images captured by camera configuration 670 at the POS system as discussed in detail above. In doing so, item identification computing device 610 may implement a multi-layer of item tracking and recognition that begins with the customer entering the store and then ends with item recognition of what the customer actually positioned at the POS system thereby increasing the threshold of confidence that the items that customer requests to purchase have been correctly identified by item identification computing device 610.

As discussed above, items may be positioned for sale at the retail location that may not be easily identified based on item parameters as such item parameters may not be as specific to the item such as the item parameters of a standard twelve ounce can of Coke. Rather, such item parameters may be associated with items such as hot dogs positioned at a roller grill of the retail location in which the hot dogs are then wrapped in aluminum foil and/or put into a container without any specific item parameters easily identifying the item as well as failing to have a UPC associated with the item. In doing so, item identification computing device 610 may fail to identify such items when simply positioned at the POS system for purchase by the customer based on the item parameters extracted from the images captured of such items at the POS system alone.

Video analytics computing device 710 may extract customer journey item parameters of such items such that item identification computing device 610 may identify such items before the customer positions such items at the POS system. Video analytics computing device 710 may extract such customer journey item parameters based on an area of interest that is defined by item identification computing device 610. The area of interest may be positioned around an area of the retail location which is pre-emptively known by item identification computing device 610 as having specific items positioned within the area of interest. For example, item identification computing device 610 may position an area of interest that surrounds the roller grill as positioned in the retail location. Item identification computing device 610 may then pre-emptively identify that hot dogs and other items are positioned at the roller grill. Video analytics computing device 710 may then extract customer journey item parameters from the images captured of the area of interest as the customer approaches the area of interest. Such customer journey item parameters extracted by video analytic computing device 710 from the images captured of the customer when within the area of interest may enable item identification computing device 610 to identify any item engaged by the customer when within the area of interest despite such items not having easily identifiable item parameters.

For example, video analytics computing device 710 may generate customer journey item parameters from the images captured by camera configuration 720 of the customer walking through the retail location. Such images may then capture the customer approaching the hot dog station in which each of the toppings and/or condiments at the hot dog station are an additional cost to the hot dog. The hot dog station is defined within an area of interest by item identification computing device 610 as having the hot dog station, the hot dogs positioned at the hot dog station, and the toppings and/or condiments positioned at the hot dog station.

The hot dog and the toppings and/or condiments do not have associated UPCs. Rather, there signage present as to the cost of the hot dog and each topping and/or condiment. Camera configuration 720 may capture the customer assembling the hot dog with different toppings and/or condiments as well as capturing the signage indicating the cost of the hot dog and the different toppings and/or condiments. Camera configuration 720 may then capture the customer wrapping the hot dog with the added toppings and/or condiments with generic aluminum foil. Camera configuration 720 may then track the customer as the customer continues the customer journey throughout the retail location as well as the placement of the hot dog with added toppings and/or condiments in the generic aluminum foil to assisted checkout computing device 650 for purchase.

Video analytics computing device 710 may then generate customer journey item parameters from the above images captured by camera configuration 720 of the customer journey of the customer throughout the retail location to purchase the hot dog based on the area of interest that surrounds the hot dog station. Video analytics computing device 710 may generate the customer journey item parameter of the customer approaching the hot dog station within the area of interest. Video analytics computing device 710 may capture the customer journey item parameters as to the different toppings and/or condiments that the customer added to the hot dog within the area of interest. Video analytics computing device 710 may generate the customer journey item parameters of the metrology of the hot dog and identify the hot dog itself within the area of interest. Video analytics computing device 710 may generate the customer journey item parameter of signage at the hot dog stand that indicates the price of the hot dog and the additional toppings and/or condiments within the area of interest. Video analytics computing device 710 may generate the customer journey item parameter of the customer wrapping the hot dog with the additional toppings and/or condiments in aluminum foil within the area of interest. Video analytics computing device 710 may generate the customer journey item parameter of tracking the hot dog wrapped with aluminum foil in the possession of the customer as the customer moves from the area of interest including the hot dog station and then throughout the retail location to when the customer presents the hot dog wrapped with aluminum foil to assisted checkout computing device 650 for purchase.

As a result, item identification computing device 610 may identify that the customer has engaged the hot dog, the toppings that the customer put on the hot dog, as well as that the customer wrapped the hot dog and toppings with aluminum foil when the customer leaves the area of interest surrounding the hot dog station based on the customer journey item parameters generated by video analytics computing device 710 as associated with the area of interest surrounding the hot dog station. Item identification computing device 610 may associate the customer journey item parameters generated by video analytics computing device 710 with the area of interest surrounding the hot dog station and thereby identify that the customer has engaged the hot dog and the toppings and wrapped such in aluminum foil before reaching the POS system.

In addition, camera configuration 670 may then capture images of the item that is not associated with a UPC as presented to assisted checkout computing device 1950. Rather than have item identification computing device 610 fail to identify the item due to the lack of distinctive item parameters as captured by camera configuration 670, item identification computing device 610 may incorporate the customer journey item parameters as generated by video analytics computing device 710 to assist item identification computing device 610 in identifying the item that is not associated with a UPC. In doing so, item identification computing device 610 may supplement the item parameters of the item that is not associated with a UPC as captured of the item by camera configuration 670 as the item is presented at assisted checkout computing device 650 with the customer journey item parameters associated with the customer journey of the customer throughout the store to further identify the item that is not associated with the UPC.

For example, item identification computing device 610 may incorporate the customer journey item parameter of the customer approaching the hot dog station in which the customer taking a hot dog. Item identification computing device 610 may incorporate the customer journey item parameter of each topping and/or condiment that the customer added to the hot dog. Item identification computing device 610 may incorporate customer journey item parameter of the signage at the hot dog station as to the cost of the hot dog and each topping and/or condiment. Item identification computing device 610 may incorporate the customer journey item parameter of the customer wrapping the hot dog and toppings and/or condiments in aluminum foil. Item identification computing device 610 may incorporate the customer journey item parameter of tracking the hot dog in possession of the customer throughout the customer journey of the retail location to when the customer presents the hot dog wrapped in aluminum foil to assisted checkout computing device 650.

Item identification computing device 610 may then supplement the item parameters as captured by camera configuration 670 of the hot dog wrapped in aluminum foil as presented at assisted checkout computing device 650 with all of the customer journey item parameters generated by video analytics computing device 610. In such an example, item identification computing device 610 may then supplement the item parameters of the metrology of the hot dog wrapped in aluminum foil with the size and shape of the hot dog as well as the visual appearance of the hot dog wrapped in aluminum foil with the customer journey item parameters of the customer approaching the hot dog station, the customer adding the toppings and/or condiments to the hot dog, the price of the hot dog and toppings and/or condiments as provided by the signage at the hot dog station, the customer wrapping the hot dog and toppings and/or condiments in the aluminum foil, and then tracking the hot dog in possession of the customer throughout the customer journey of the retail location to the customer presenting the hot dog wrapped in aluminum foil to assisted checkout computing device 650 for purchase. In doing so, the customer journey item parameters provide significant additional insight to the identification of the hot dog by item identification computing device 610 when the hot dog is not associated with a UPC and the item parameters of the hot dog wrapped in generic aluminum foil fails to provide sufficient indication as to the identity of the hot dog for item identification computing device 610.

Video analytics computing device 710 may also extract customer journey item parameters of such items such that item identification computing device 610 may identify such items before the customer positions such items at the POS system. Video analytics computing device 710 may extract such customer journey item parameters based on a planogram of the retail location that is generated by the retailer such that item identification computing device 610 may identify such items before the customer positons such items at the POS system. The planograms of the retail location as generated by the retailer are visual representations in how items are displayed in a store for purchase. As discussed above, the retailer may position items throughout the retail location in order to increase the effectiveness of sales and marketing of the items. In doing so, the retailer generates planograms which depict how the retailer positions each of the items throughout the retail location. Video analytics computing device 710 may then generate customer journey item parameters based on the planogram of the items positioned within the planogram and engaged by the customer. Item identification computing device 610 may then associate such customer journey item parameters with the items within the planogram thereby enabling item identification computing device 610 to identify such items within the planogram.

In doing so, item identification computing device 610 may be able to identify items that are not easily identifiable based on the images captured of such items by camera configuration 720 positioned throughout the retail location. As discussed above, camera configuration 720 may include cameras that are pre-existing within the retail location and such pre-existing cameras may have lower resolution in capturing images. Often times, an item that is engaged by the customer within a planogram may have item parameters that are unrecognizable based on the low resolution images captured by the pre-existing cameras positioned throughout the retail location. Item identification computing device 610 may then associate the customer journey item parameters as generated by video analytics computing device 710 with the items positioned within the planogram in which the customer engaged the item. Such customer journey item parameters may identify the items that are positioned within the planogram that the customer engaged the item as the planogram provides to item identification computing device 610 each of the pre-existing items that are positioned within the planogram. Item identification computing device 610 may then differentiate the items that the customer engages within the planogram based on the pre-existing items positioned within the planogram and the customer journey item parameters generated by video analytics computing device 710 to identify the item despite the pre-existing cameras failing to generate images with item parameters that depict the identity of the item.

For example, camera configuration 720 may capture images of the customer entering an aisle in which gum is positioned in which the customer engages a package of gum positioned on a shelf in the aisle. However the pre-existing cameras of camera configuration 720 fail to have sufficient resolution to depict image parameters that identify the gum as the package of gum is too small for item identification computing device 610 to adequately identify the gum as engaged by the customer from the images captured of the gum. Rather than simply failing to identify the gum as engaged by the customer, video analytics computing device 710 may then extract customer journey item parameters from the images captured of the planogram as the customer approaches area within the planogram. Such customer journey item parameters extracted by video analytic computing device 710 from the images captured of the customer when within the area of the planogram may enable item identification computing device 610 to identify any item engaged by the customer when within the planogram despite such items not having easily identifiable item parameters.

In doing so, item identification computing device 610 may then pre-emptively identify that gum is positioned in the aisle in which the customer engaged the unknown item based on the planogram identifying that such aisle is where gum is positioned. Video analytics computing device 710 may then extract customer journey item parameters from the images captured of the area included in the planogram as the customer approaches the area. Such customer journey item parameters extracted by video analytic computing device 710 from the images captured of the customer when within the area included in the planogram may enable item identification computing device 610 to identify any item engaged by the customer when within the area included in the planogram despite such items not having easily identifiable item parameters.

Item identification computing device 610 may then associate the customer journey item parameters generated by video analytics computing device 710, such as the metrology of the unknown item, with the planogram in which item identification computing device 610 pre-emptively recognizes that the gum is positioned within the planogram that the customer engaged the unknown item. Item identification computing device 610 may then identify the unknown item engaged by the customer as the gum based on the metrology of the unknown item and other customer journey item parameters associated with the unknown item as the gum as such customer journey item parameters align with the items positioned within the planogram as being gum.

Video analytics computing device 710 may also extract customer journey item parameters of items such that item identification computing device 610 may then determine when the customer is failing to accurately provide the items in which the customer engaged during the customer journey through the retail location for purchase at the POS system. Video analytics computing device 710 may track the customer as the customer maneuvers through the retail location based on the images captured by camera configuration 720 and generate customer journey item parameters for the items that the customer engages but then conflict with the item parameters extracted from the images captured of the items that the customer actually positioned at the POS system as captured by camera configuration 650. In doing so, item identification computing device 610 may then determine that the customer is attempting to avoid purchasing the items that the customer is attempting to depart the retail location with. As a result, item identification computing device 610 may increase loss prevention by the retailer by identifying when the customer is avoiding purchase of items in which the customer is attempting to depart the retail location with.

Video analytics computing device 710 may extract customer journey item parameters of items such that item identification computing device 610 may determine when the customer is misrepresenting a quantity of an item. The customer misrepresents the quantity of an item when the customer attempts to represent at the POS system that the customer is attempting to purchase a decreased quantity of the item but when is actually attempting to depart the retail location with an increased quantity of an item when only paying for the decreased quantity. For example, the customer may approach the pizza roller grill where several pieces of pizza are positioned on the pizza roller grill. The customer may then position two pieces of pizza from the pizza roller grill into a single pizza container in which only a single piece of pizza should be positioned in the single pizza container rather than two. The customer may then positon the single pizza container and attempt to pay for a single piece of pizza when in actuality the customer has two pieces of pizza positioned in the single pizza container. The customer would then depart the retail location with the two pieces of pizza when only paying for a single piece of pizza if successful.

In such an example, video analytics computing device 710 may track the customer as the customer approaches the pizza roller grill and generate customer journey item parameters that identify that the customer is positioning two pieces of pizza in a single pizza container. Video analytics computing device 710 may then track the customer as the customer positions the single pizza container at the POS system and attempts to pay for a single piece of pizza when in actuality the customer has two pieces of pizza positioned in the single pizza container. Camera configuration 670 may capture images of the single pizza container positioned at the POS system.

However, item identification computing device 610 may recognize based on the customer journey item parameters generated by video analytics computing device 710 that the customer actually positioned two pieces of pizza in the single pizza container rather than one piece of pizza and in actuality the customer is attempting to depart with two pieces of pizza when attempting to purchase just one piece of pizza. Item identification computing device 610 may then generate an alert so that the cashier and/or manager located at the retail location are aware that the customer is attempting to depart with two pieces of pizza when only paying for one piece of pizza such that the cashier and/or manager may determine how to address the situation. As a result, item identification computing device 610 may increase loss prevention while doing so in a subtle manner without creating an unnecessary scene at the POS system.

Video analytics computing device 710 may extract customer journey item parameters of items such that item identification computing device 610 may determine when the customer is misrepresenting the actual item. The customer misrepresents actual item the when the customer attempts to represent at the POS system that the customer is attempting to purchase an item when is actually attempting to depart the retail location with a different item that is typically decreased in price than the item that the customer is attempting to present at the POS system. For example, the customer may initially approach the drink coolers and obtain a can of Red Bull. The customer may then approach the soda fountain center and obtain a soda fountain cup. The customer may then poor the Red Bull into the soda fountain cup and approach the POS system with the soda fountain cup that is filled with Red Bull and not a fountain drink from the soda fountain center. In doing so, the customer is attempting to purchase soda fountain drink when in actuality the customer is attempting to depart the retail center with the Red Bull when paying the price for the soda fountain drink which is less than the price of the Red Bull. The customer would then depart the retail location with the Red Bull when only paying for the soda fountain drink if successful.

In such an example, video analytics computing device 710 may track the customer as the customer approaches the drink coolers and generate customer journey item parameters that identify that the customer is obtaining the can of Red Bull from the drink coolers. Video analytics computing device 710 may then track the customer as the customer approaches the soda fountain center that identify that the customer obtains a soda fountain cup. Video analytics computing device 710 may then track the customer as the customer fails to engage the soda fountain center to fill the soda fountain cup with soda. Video analytics computing device 710 may then track the customer as the customer approaches the POS system to position the soda fountain cup at the POS system to purchase the soda fountain cup. Camera configuration 670 may capture images of the soda fountain cup positioned at the POS system.

However, item identification computing device 610 may recognize that based on the customer journey item parameters generated by video analytics computing device 710 that the customer failed to fill the soda fountain cup with soda from the soda fountain center while also recognizing that the customer obtained the can of Red Bull from the drink coolers without returning the can of Red Bull to the drink coolers. Item identification computing device 610 may also recognize that the customer failed to position the can of Red Bull at the POS system for purchase in addition to the soda fountain cup. In doing so, item identification computing device 610 may recognize that the customer has poured the Red Bull into the soda fountain cup and is attempting to depart the retail location with the Red Bull while paying the price for the soda fountain cup filled with soda. Item identification computing device 610 may then generate an alert so that the cashier and/or manager located at the retail location are aware that the customer is attempting to depart with the Red Bull when only paying for the soda fountain cup filled with soda such that the cashier and/or manager may determine how to address the situation. As a result, item identification computing device 610 may increase loss prevention while doing so in a subtle manner without creating an unnecessary scene at the POS system.

Video analytics computing device 710 may extract customer journey item parameters of items such that item identification computing device 610 may determine when the customer is failing to position an item at the POS system for purchase. The customer fails to positon the item at the POS system for purchase when the customer is attempting to depart the retail location without purchasing the item. Returning to the example in which the customer obtains the package of gum, the customer may initially approach the gum aisle and obtain the package of gum. The customer may then approach the chip aisle and obtain the package of chips. The customer may then approach the POS system and position the package of chips at the POS system for purchase but refrains from positioning the package of gum at the POS system for purchase. In doing so, the customer is attempting to depart the retail location without paying for the package of gum.

As discussed in detail above in the same example, video analytics computing device 710 may track the customer as the customer approaches the gum aisle and based on the planogram and/or area of interest, may identify that the customer is obtaining the package of gum. Video analytics computing device 710 may then track the customer as the customer approaches the chip aisle and obtains the back of chips based on the planogram and/or area of interest. Video analytics computing device 710 may then track the customer as the customer may then track the customer as the customer as the customer approaches the POS system to position the bag of chips at the POS system but fails to position the package of gum at the POS system. Camera configuration 670 may capture images of the bag of chips positioned at the POS system without the package of gum also positioned at the POS system.

However, item identification computing device 610 may recognize that based on the customer journey item parameters generated by video analytics computing device 710 that the customer obtained the package of gum from the gum aisle and the bag of chips from the chip aisle. Item identification computing device 610 may also recognize that based on the customer journey item parameters generated by video analytics computing device 710 that the customer did not position the package of gum back at the gum aisle. Item identification computing device 610 may then compare the customer journey item parameters generated by video analytics computing device 710 that the customer obtained the package of gum and the package of chips with the item parameters captured from the images of the bag of chips as positioned at the POS system to determine that the package of gum is missing from the POS system. Based on the multi-layered authentication of video analytics computing device 710 tracking the customer through the retail location and obtaining the package of gum while item identification computing device 610 failing to identify that the package of gum is positioned at the POS system for purchase, item identification computing device 610 may automatically add the package of gum to the items of purchase for the customer. As a result, item identification computing device 610 may increase loss prevention while doing so in a subtle manner without creating an unnecessary scene at the POS system.

Video analytic item identification configuration 700 may correlate the customer interactions in the retail location from the customer journey item parameters as generated video analytics computing device 710 with the product placement/planogram information as also generated as customer journey item parameters by item identification computing device 610 to countertop device predictions based on item parameters of the item by item identification computing device 610 which may improve the confidence of large-scale classification models. To integrate the customer journeys based on customer journey item parameters as generated by video analytics computing device 710 with the countertop device predictions based on item parameters as generated by item identification computing device 610, cross-modal noisy information may be combined to generate a final list of checkout predictions by item identification computing device 610.

A list of information sources may be expanded. Countertop scanning predictions may include outputs and confidences of classification models that includes known, unknown and sizes from the countertop multi-view camera setup of assisted checkout computing device 650 and camera configuration 670. POS sales history may be provided to item identification computing device 610 from an increased quantity of retail locations in different regions over a long time duration. Customer journeys may be noisy real-time customer tracks generated from the multi-cam tracker in camera configuration 620 and generated by video analytics computing device 710.

Video analytics computing device 710 may generate a history of customer journeys/tracks and heat maps which may provide insights into general shopping behaviors. Customer interactions may be generated by video analytics computing device 710 may in which human interaction models may identify picking and placing of products along with people gazing predictions. Video analytics computing device 710 may also generate area of interest and heuristic based coffee, fountain, and roller grill analytics which may generate a shortlist identifying those specific items for item identification computing device 610 to analyze first in identifying such items. Video analytics computing device 710 may generate planogram and product placement information for all of the items positioned in the retail locations of the retailer. In doing so, video analytics computing device may generate the granularity at an aisle/rack level and this may be a little noisy since errors are possible in stores.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A system for automatically identifying a plurality of items positioned at a point of sale (POS) system based on a plurality of item parameters associated with each item as provided by a plurality of images captured by a plurality of cameras positioned at the POS system, comprising:
at least one processor;
a memory coupled with the at least one processor, the memory including instructions that, when executed by the at least one processor cause the at least one processor to:
extract the plurality of item parameters associated with each item positioned at the POS system from the plurality of images captured of each item by the plurality of cameras positioned at the POS system, wherein the item parameters associated with each item when combined are indicative as to an identification of each corresponding item thereby enabling the identification of each corresponding item,
analyze the item parameters associated with each item positioned at the POS system to determine whether the item parameters associated with each item when combined matches a corresponding combination of the item parameters stored in an item parameter identification database, wherein the item parameter identification database stores different combinations of item parameters with each different combination of item parameters associated with a corresponding item thereby identifying each corresponding item based on each different combination of item parameters associated with each corresponding item,
identify each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters, and
stream the item parameters associated with each item positioned at the POS system that fail to match to the item parameter identification database thereby enabling the identification of each failed item when the combination of item parameters of each failed item are subsequently identified when subsequently positioned at the POS system after the failed match.

2. The system of claim 2, wherein the processor is further configured to:
automatically extract the item parameters associated with each item positioned at the POS system from the images captured of each item that failed to be identified as POS data, wherein the POS data depicts the item parameters captured at the POS system and identified as failing to match a corresponding combination of item parameters stored in the item parameter identification database; and
automatically stream the POS data and each corresponding image captured of each item positioned at the POS system that failed to match a corresponding combination of item parameters stored in the item parameter identification database to an item identification server.

3. The system of claim 2, wherein the processor is further configured to:
automatically receive updated streamed POS data associated with each image captured of each item that failed to be identified as trained on a neural network based on machine learning as the neural network continuously updates the streamed POS data based on past POS data as captured from past images captured of each item previously positioned at the POS system that failed be identified as streamed from the item identification server;
analyze the updated streamed POS data as provided by the neural network to determine a plurality of identified item parameters associated with each item currently positioned at the POS system that failed to be identified when previously positioned at the POS system, wherein the identified item parameters associated with each are indicative to an identity of each item currently positioned at the POS system when each item when previously positioned at the POS system failed to match a corresponding combination of item parameters as stored in the item parameter identification database; and
automatically identify each corresponding item currently positioned at the POS system when the identified item parameters associated with each item as provided by the neural network when combined match the corresponding combination of item parameters associated with each item as stored in the item parameter identification database.

4. The system of claim 3, wherein the processor is further configured to:
continuously stream POS data as automatically extracted from the item parameters associated with each item positioned at a plurality of POS systems from the corresponding plurality of images captured of each item positioned at each corresponding POS system that fails to be identified to the item identification server for the neural network to incorporate into the determination of identified item parameters for each of the items positioned at each corresponding POS system.

5. The system of claim 4, wherein the processor is further configured to:
automatically receive updated streamed POS data associated with each image captured of each item previously positioned at each corresponding POS system as trained on by the neural network based on machine learning as the neural network continuously updates the streamed POS data based on the past POS data as captured from past images captured of each item previously positioned at each of the POS systems, wherein the neural network is trained on with an increase in the POS data associated with each item that fails be identified to match due to an increase the POS systems that each item is positioned and fails to identify each item;
analyze the updated streamed POS data as provided by the neural network based on the POS data provided by each of the POS systems to determine the plurality of identified item parameters associated with each item currently positioned at each POS system that failed to be identified when previously positioned at each POS system; and
automatically identify each corresponding item currently positioned at each POS system when the identified item parameters associated with each item as provided by the neural network when combined match the corresponding combination of item parameters associated with each item as stored in the item parameter identification database, wherein each corresponding item is automatically identified in a decreased duration of time due to the increase in the POS data associated with each item based on the increase in the POS systems that each item previously failed to be identified.

6. The system of claim 3, wherein the processor is further configured to:
automatically map the images captured of each item positioned at the POS system that failed to be identified to a corresponding POS record, wherein the POS record is generated by the POS system for each item that is positioned at the POS system;
automatically extract the POS data as generated from the item parameters extracted from each of the images captured of each item positioned at the POS system from the images captured of each item that failed to be identified; and
automatically generate a data set for each item that failed to be identified that matches each corresponding POS record to the corresponding images captured of each item when positioned at the POS system thereby generating the corresponding POS record, wherein the POS data extracted from each of the images captured of each item that failed to be identified is incorporated into the data set of each item that failed to be identified based on the mapping of the images of each item that failed to be identified to the corresponding POS record.

7. The system of claim 6, wherein the processor is further configured to:
automatically stream the POS data and each corresponding image captured of each item positioned at the POS system that failed to be identified to the item identification server as included in each data set associated with each item that failed to be identified to be trained on the neural network based on machine learning as the neural network continuously updates the streamed POS data as included in each data set based on past POS data included in the data set as captured from past images captured of each item previously positioned at the POS system that failed to be identified.

8. The system of claim 7, wherein the processor is further configured to:
identify a first item when the POS data associated with the first item as generated from the item parameters extracted from each of the images captured by the cameras positioned at the POS system match POS data as included in a corresponding first data set thereby identifying the first item and fail to identify a second item when POS data associated with the second item as generated from the item parameters extracted from each of the images captured by the cameras positioned at the POS system fail to match POS data as included in a data set thereby failing to identify the second item;
automatically map the POS data of the second item and the images captured of the second item to a second POS record generated by the POS system for the second item as positioned at the POS system to generate a second data set for the second item;
automatically stream the POS data of the second item and the images captured of the second item as mapped to the second POS record of the second item as included in the second data set to the item identification server to be trained on the neural network based on machine learning as the neural network continuously updates the streamed POS data as included in the second data set each time the second item is positioned at the POS system and images are captured of the second item; and
automatically identify the second item when the POS data associated with the second item as generated from the item parameters as extracted from each of the images captured by the cameras positioned at the POS system match the POS data included in the second data set as trained on by the neural network thereby identifying the second item.

9. The system of claim 6, wherein the processor is further configured to:
automatically extract a plurality of features associated with each item positioned at the POS system from the images captured of each item that failed to be identified;
automatically map the features associated with each item positioned at the POS system that failed to be identified to a corresponding POS record; and
automatically generate a corresponding feature vector that includes the features associated with each corresponding item positioned POS system that failed to be identified to map each corresponding feature vector to each corresponding data set for each item that failed to be identified based on the POS record for each item that failed to be identified.

10. The system of claim 9, wherein the processor is further configured to:
automatically stream each corresponding feature vector and each corresponding image captured of each item positioned at the POS system that failed to be identified to the item identification server as included in each data set associated with each item that failed to be identified to be trained on the neural network based on machine learning updates the streamed feature vectors as included in each data set to associate the features of each corresponding item to identify each item that failed to be identified based on the features included in each corresponding feature vector for each item.

11. A method for automatically identifying a plurality of items positioned at a Point of Sale (POS) system based on a plurality of item parameters associated with each item as provided by a plurality of images captured by a plurality of cameras positioned at the POS system, comprising:
extracting the plurality of item parameters associated with each item positioned at the POS system from the plurality of images captured of each item by the plurality of cameras positioned at the POS system, wherein the item parameters associated with each item when combined are indicative as to an identification of each corresponding item thereby enabling the identification of each corresponding item;
analyzing the item parameters associated with each item positioned at the POS system to determine whether the item parameters associated with each item when combined matches a corresponding combination of the item parameters stored in an item parameter identification database, wherein the item parameter identification database stores different combinations of item parameters with each different combination of item parameters associated with a corresponding item thereby identifying each corresponding item based on each different combination of item parameters associated with each corresponding item;
identifying each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters; and
streaming the item parameters associated with each item positioned at the POS system that fail to match to the item parameter identification database thereby enabling the identification of each failed item when the combination of item parameters of each failed item are subsequently identified when subsequently positioned at the POS system after the failed match.

12. The method of claim 11, further comprising:
automatically extracting the item parameters associated with each item positioned at the POS system from the images captured of each item that failed to be identified as POS data, wherein the POS data depicts the item parameters captured at the POS system and identified as failing to match a corresponding combination of item parameters stored in the item parameter identification database; and
automatically streaming the POS data and each corresponding image captured of each item positioned at the POS system that failed to match a corresponding combination of item parameters stored in the item parameter identification database to an item identification server.

13. The method of claim 12, further comprising:
automatically receiving updated streamed POS data associated with each image captured of each item that failed to be identified as trained on a neural network based on machine learning as the neural network continuously updates the streamed POS data based on past POS data as captured from past images captured of each item previously positioned at the POS system that failed to be identified as streamed from the item identification server;
analyzing the updated streamed POS data as provided by the neural network to determine a plurality of identified item parameters associated with each item currently positioned at the POS system that failed to be identified when previously positioned at the POS system, wherein the identified item parameters associated with each are indicative to an identify of each item currently positioned at the POS system when each item when previously positioned at the POS system failed to match a corresponding combination of item parameters as stored in the item parameter identification database; and
automatically identifying each corresponding item currently positioned at the POS system when the identified item parameters associated with each item as provided by the neural network when combined match the corresponding combination of item parameters associated with each item as stored in the item parameter identification database.

14. The method of claim 13, further comprising:
continuously streaming POS data as automatically extracted from the item parameters associated with each item positioned at a plurality of POS systems from the corresponding plurality of images captured of each item positioned at each corresponding POS system that fails to be identified to the item identification server for the neural network to incorporate into the determination of identified item parameters for each of the items positioned at each corresponding POS system.

15. The method of claim 14, further comprising:
automatically receiving updated streamed POS data associated with each image captured of each item previously positioned at each corresponding POS system as trained on by the neural network based on machine learning as the neural network continuously updates the streamed POS data based on the past POS data as captured from past images captured of each item previously positioned at each of the POS systems, wherein the neural network is trained on with an increase in the POS data associated with each item that fails to be identified to match due to an increase in the POS systems that each item is positioned and fails to identify each item;
analyzing the updated streamed POS data as provided by the neural network based on the POS data provided by each of the POS systems to determine the plurality of identified item parameters associated with each item currently positioned at each POS system that failed to be identified when previously positioned at each POS system; and
automatically identifying each corresponding item currently positioned at each POS system when the identified item parameters associated with each item as provided by the neural network when combined match the corresponding combination of item parameters associated with each item as stored in the item parameter identification database, wherein each corresponding item is automatically identified in a decreased duration of time due to the increase in the POS data associated with each item based on the increase in the POS systems that each item previously failed to be identified.

16. The method of claim 13, further comprising:
automatically mapping the images captured of each item positioned at the POS system that failed to be identified to a corresponding POS record, wherein the POS record is generated by the POS system for each item that is positioned at the POS system;
automatically extracting the POS data as generated from the item parameters extracted from each of the images captured of each item positioned at the POS system from the images captured of each item that failed to be identified; and
automatically generating a data set for each item that failed to be identified that matches each corresponding POS record to the corresponding images captured of each item when positioned at the POS system thereby generating the corresponding POS record, wherein the POS data extracted from each of the images captured of each item that failed to be identified is incorporated into the data set of each that failed to be identified based on the mapping of the images of each item that failed to be identified to the corresponding POS record.

17. The method of claim 16, further comprising:
automatically streaming the POS data and each corresponding image captured of each item positioned at the POS system that failed to be identified to the item identification server as included in each data set associated with each item that failed to be identified to be trained on the neural network based on machine learning as the neural network continuously updates the streamed POS data as included in each data set based on past POS data included in the data set as captured from past images captured of each item previously positioned at the POS system that failed to be identified.

18. The method of claim 17, further comprising:
identifying a first item when the POS data associated with the first item as generated from the item parameters extracted from each of the images captured by the cameras positioned at the POS system match POS data as included in a corresponding first data set thereby identifying the first item and fail to identify a second item when POS data associated with the second item as generated from the item parameters extracted from each of the images captured by the cameras positioned at the POS system fail to match POS data as included in a data set thereby failing to identify the second item;
automatically mapping the POS data of the second item and the images captured of the second item to a second POS record generated by the POS system for the second item as positioned at the POS system to generate a second data set for the second item;
automatically streaming the POS data of the second item and the images captured of the second item as mapped to the second POS record of the second item as included in the second data set to the item identification server to be trained on the neural network based on machine learning as the neural network continuously updates the streamed POS data as included in the second data set each time the second item is positioned at the POS system and images are captured of the second item; and
automatically identifying the second item when the POS data associated with the second item as generated from the item parameters as extracted from each of the images captured by the cameras positioned at the POS system match the POS data include in the second data set as trained on by the neural network thereby identifying the second item.

19. The method of claim 16, further comprising:
automatically extracting a plurality of features associated with each item positioned at the POS system from the images captured of each item that failed to be identified;
automatically mapping the features associated with each item positioned at the POS system that failed to be identified to a corresponding POS record; and
automatically generating a corresponding feature vector that includes the features associated with each corresponding item positioned at the POS system that failed to be identified to map each corresponding feature vector to each corresponding data asset for each item that failed to be identified based on the POS record for each item that failed to be identified.

20. The method of claim 19, further comprising:
automatically streaming each corresponding feature vector and each corresponding image captured of each item positioned at the POS system that failed to be identified to the item identification server as included in each data set associated with each item that failed to be identified to be trained on the neural network based on machine learning updates the streamed feature vectors as included in each data set to associate the features of each corresponding item to identify each item that failed to be identified based on the features included in each corresponding feature vector for each item.
